(19) United States
(12) Patent Application Publication
(10) Pub. No.: US 2023/0184555 A1
(43) Pub. Date: Jun. 15, 2023

(54) LANE ESTIMATION APPARATUS AND LANE ESTIMATION METHOD

(71) Applicant: Honda Motor Co., Ltd., Tokyo (JP)

(72) Inventors: Akira Iihoshi, Tokyo (JP); Atsuki Kakinuma, Tokyo (JP); Yasuo Oishi, Tokyo (JP); Takeo Tokunaga, Tokyo (JP); Hiroyuki Onimaru, Tokyo (JP)

(21) Appl. No.: 17/926,618

(22) PCT Filed: Apr. 28, 2021
(86) PCT No.: PCT/JP2021/016984

§ 371 Date: Nov. 20, 2022

(30) Foreign Application Priority Data
May 22, 2020 (JP) 2020-089655

(51) Int. Cl. G01C 21/28; G01C 21/00

(52) U.S. Cl. CPC G01C 21/28; G01C 21/3848; G01C 21/3815; G01C 21/3885

(57) ABSTRACT

A lane estimation apparatus including a microprocessor. The microprocessor is configured to perform determining whether a precision of positioning is equal to or larger than a predetermined value based on precision information, identifying a traveling lane based on position information and road map information when it is determined that the precision of positioning is equal to or larger than the predetermined value, then when it is determined that the precision of positioning is smaller than the predetermined value, determining whether a lane change has been made from the traveling lane identified when it has been determined that the precision of positioning is equal to or larger than the predetermined value, based on driving information and information on a road surface profile included in the road map information, and identifying the traveling lane in accordance with a determination result.

### CROSS-REFERENCE TO RELATED APPLICATION

This application is a National Stage of PCT international application Ser. No. PCT/JP2021/016984 filed on Apr. 28, 2021 which designates the United States, incorporated herein by reference, and which is based upon and claims the benefit of priority from Japanese Patent Application No. 2020-089655, filed on May 22, 2020, the entire contents of which are incorporated herein by reference.

### TECHNICAL FIELD

This invention relates to a lane estimation apparatus and lane estimation method that estimates a lane in which a vehicle is traveling.

### BACKGROUND ART

Conventionally, as an apparatus of this type, there is known an apparatus that compares each of road surface profiles of a plurality of lanes that have been registered beforehand with a road surface profile measured while a vehicle is traveling, calculates a similarity in the road surface profile for each of the plurality of lanes, and estimates a lane having a high similarity as a lane while the vehicle is traveling (see, for example, Patent Literature 1).

### CITATION LIST

### Patent Literature

Patent Literature 1: Japanese Unexamined Patent Publication No. 2016-45063

### DISCLOSURE OF INVENTION

### Problems to be Solved by the Invention

However, the position of the tire or the like in a width direction in the lane in which the vehicle travels may be different for every vehicle. For this reason, like the apparatus described in Patent Literature 1, in estimating the lane, based on the similarity in the road surface profile, it is difficult to precisely estimate the lane while the vehicle is traveling.

### Means for Solving Problem

An aspect of the present invention is a lane estimation apparatus including: a position information acquisition unit that acquires position information acquired by a positioning sensor, the positioning sensor measuring a position of a vehicle by receiving a signal transmitted from a positioning satellite; a precision information acquisition unit that acquires precision information of positioning by the positioning sensor; a driving information acquisition unit that acquires driving information of the vehicle, the driving information including information on a detection value detected by a detector, the detection value varying in accordance with a road surface profile of a road surface on which the vehicle travels; a road map information acquisition unit that acquires road map information including information on a road lane and information on the road surface profile; and a traveling lane identification unit that identifies a traveling lane in which the vehicle travels, based on the position information acquired by the position information acquisition unit, the precision information acquired by the precision information acquisition unit, the driving information acquired by the driving information acquisition unit and the road map information acquired by the road map information acquisition unit. The traveling lane identification unit determines whether a precision of positioning is equal to or larger than a predetermined value based on the precision information acquired by the precision information acquisition unit, identifies the traveling lane based on the position information acquired by the position information acquisition unit and the road map information acquired by the road map information acquisition unit when it is determined that the precision of positioning is equal to or larger than the predetermined value, determines whether a lane change has been made from the traveling lane identified when it has been determined that the precision of positioning is equal to or larger than the predetermined value, based on the driving information acquired by the driving information acquisition unit and the information on the road surface profile included in the road map information acquired by the road map information acquisition unit, when it is determined that the precision of positioning is smaller than the predetermined value since it is determined that the precision of positioning has been equal to or larger than the predetermined value, and identifies the traveling lane in accordance with a determination result of the lane change.

Another aspect of the present invention is a lane estimation method, including causing a computer to execute steps of: acquiring position information acquired by a positioning sensor, the positioning sensor measuring a position of a vehicle by receiving a signal transmitted from a positioning satellite; acquiring precision information of positioning by the positioning sensor; acquiring driving information of the vehicle, the driving information including information on a detection value detected by a detector, the detection value varying in accordance with a road surface profile of a road surface on which the vehicle travels; acquiring road map information including information on a road lane and information on the road surface profile; and identifying a traveling lane in which the vehicle travels, based on the position information acquired, the precision information acquired, the driving information acquired and the road map information acquired. The identifying includes determining whether a precision of positioning is equal to or larger than a predetermined value based on the precision information acquired, identifying the traveling lane based on the position information acquired and the road map information acquired when it is determined that the precision of positioning is equal to or larger than the predetermined value, determining whether a lane change has been made from the traveling lane identified when it has been determined that the precision of positioning is equal to or larger than the predetermined value based on the driving information acquired and the information on the road surface profile included in the road map information acquired, when it is determined that the precision of positioning is smaller than the predetermined value since it is determined that the precision of positioning has been equal to or larger than the predetermined value, and identifying the traveling lane in accordance with a determination result of the lane change.

### Effect of the Invention

According to the present invention, a lane in which a vehicle is traveling can be estimated with high accuracy.

### BRIEF DESCRIPTION OF THE DRAWINGS

FIG. 1 is a diagram schematically illustrating an example of a road on which a plurality of lanes are present;

FIG. 2 is a diagram illustrating an overall configuration of a lane estimation system including a lane estimation apparatus according to the embodiment of the present invention;

FIG. 3 is a diagram illustrating an example of a road surface profile acquired by a server device in FIG. 2;

FIG. 4 is a block diagram illustrating a functional configuration of the lane estimation apparatus according to the embodiment of the present invention; and

FIG. 5 is a flowchart illustrating an example of processing executed by a controller in FIG. 4.

### DESCRIPTION OF EMBODIMENT

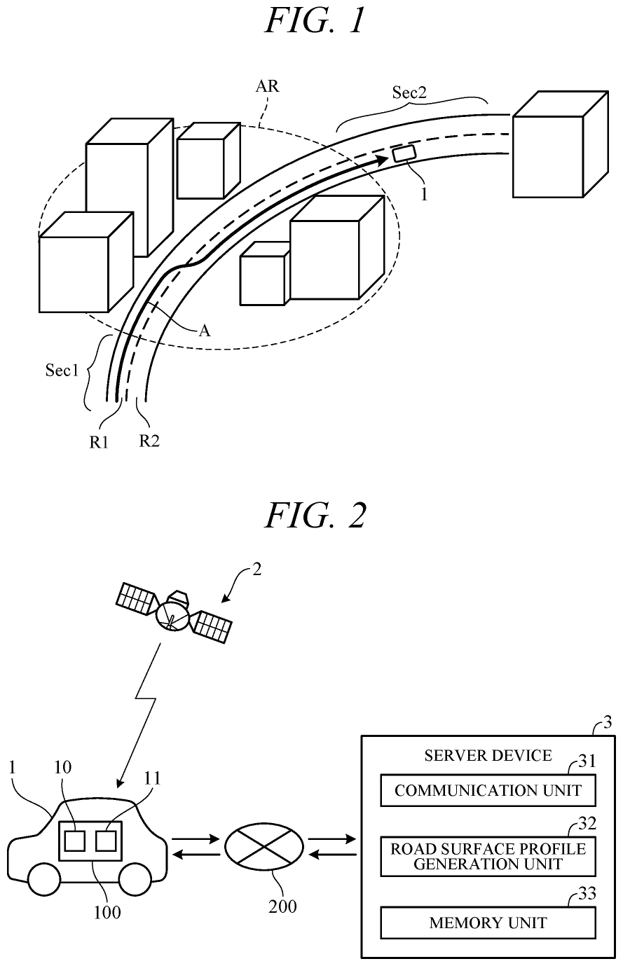

Now, an embodiment of the present invention will be described with reference to FIGS. 1 to 5. A lane estimation apparatus according to an embodiment of the present invention is configured to estimate a traveling lane on which a vehicle is traveling, when the vehicle travels on a road on which a plurality of traveling lanes are present. When the traveling lane is estimated, prediction of traffic congestion for every lane, creation of a road surface profile indicating an uneven state of a road surface, estimation of a position where a troubled vehicle is stopped, estimation of a reversely traveling vehicle, and the like are easily achievable.

Estimation of the traveling lane is enabled by a positioning sensor such as a GPS receiver (GPS sensor) mounted on the vehicle receiving signals from an artificial satellite for positioning (positioning satellite) such as a global positioning system (GPS), measuring the position of the vehicle, and comparing the measured position of the vehicle with the position of the lane included in map information. That is, if the positioning precision in the case of measuring the position of the vehicle with use of the positioning sensor has precision enough to identify the position of a lane, the position of the lane can be precisely estimated by use of the positioning sensor.

However, in a building area where high-rise buildings are built closely together, in a tunnel, or the like, the precision of positioning decreases. Hence, it is difficult to precisely estimate the position of the lane with use of the positioning sensor. FIG. 1 is a diagram schematically illustrating an example of a road on which a plurality of lanes (for example, a first lane R1 and a second lane R2) are present, as a three-dimensional map. An arrow A in the drawing is a traveled path of a vehicle 1.

An area AR in FIG. 1 is a building area where high-rise buildings are built closely together, and the positioning precision is low in a case where a vehicle travels on a road surrounded by the high-rise buildings in the building area (area AR). Therefore, when the vehicle 1 changes lanes from the first lane R1 to the second lane R2 in the area AR as illustrated, there is a possibility that it is impossible for the positioning sensor to precisely estimate the location point where the lane change has been made and the lane after the lane change. In consideration of such a possibility, a lane estimation apparatus is configured as follows in the present embodiment.

FIG. 2 illustrates the overall configuration of a lane estimation system including the lane estimation apparatus according to an embodiment of the present invention. As illustrated in FIG. 2, the lane estimation system includes an in-vehicle device 100 mounted on the vehicle 1 and a server device 3 that can communicate with the in-vehicle device 100 via a network 200. The vehicle 1 is a manual driving vehicle driven manually by a driver, for example.

The in-vehicle device 100 includes a positioning sensor 10 that receives signals for positioning transmitted from a positioning satellite 2 and a communication unit 11 that communicates with the server device 3 via the network 200. The positioning satellite 2 is an artificial satellite such as a GPS satellite or quasi-zenith satellite. The current position (latitude, longitude, and altitude) of the vehicle 1 can be calculated using positioning information from the positioning satellite 2 received by the positioning sensor 10.

The network 200 includes not only public wireless communication networks, such as Internet networks and cellular phone networks, but also closed communication networks provided for each predetermined management area, such as wireless LAN, Wi-Fi (registered trademark), and Bluetooth (registered trademark). The server device 3 is configured as, for example, a single server or a distributed server including separate servers for each function. The server device 3 may also be configured as a distributed virtual server created in a cloud environment called a cloud server.

The server device 3 is configured to include a processing device including a CPU, a ROM, a RAM, and other peripheral circuits, and its functional configuration includes a communication unit 31, a road surface profile generation unit 32, and a memory unit 33.

The communication unit 31 is configured to be capable of wireless communication with the in-vehicle device 100 via the network 200, and acquires the position information of the vehicle 1 and the driving information of the vehicle 1 via the communication unit 11 of the vehicle 1. The position information is information indicating the current position of the vehicle 1 calculated by the signals received by the positioning sensor 10 of the vehicle 1. The driving information is information indicating the driving state of the vehicle 1 acquired by various sensors mounted on the vehicle 1. The driving information includes information on the detected values by the acceleration sensor (lateral acceleration sensor) that detects the acceleration (lateral acceleration) of the vehicle 1 in the left-right direction. The communication unit 31 constantly acquires position information and driving information not only for the vehicle 1 (subject vehicle), which is subject to an estimation of traveling lane but also for a plurality of vehicles 1 other than the subject vehicle.

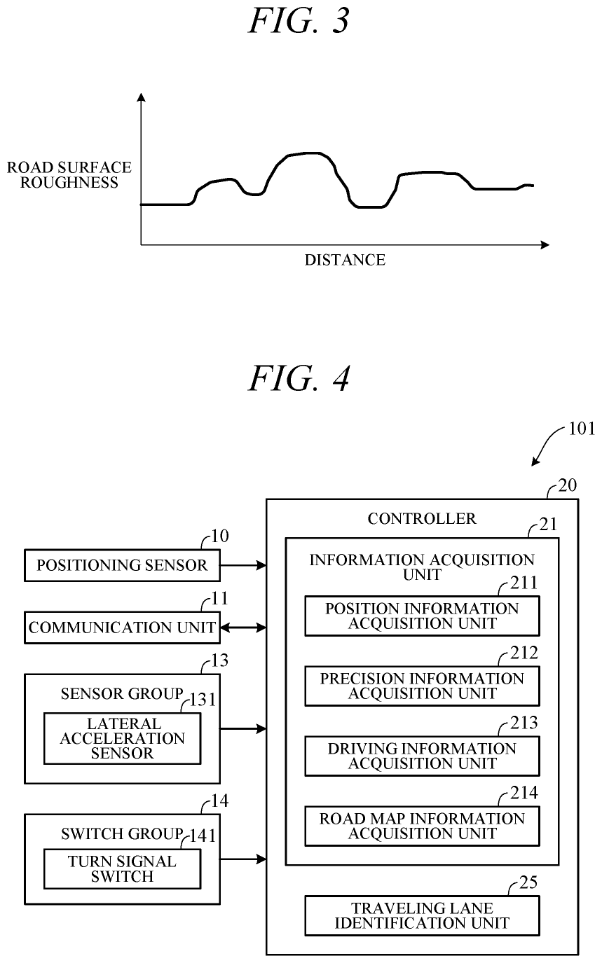

The road surface profile generation unit 32 generates a road surface profile indicating a road surface property, based on the position information and the driving information of the plurality of vehicles 1 that have been acquired via the communication unit 31, other than the target vehicle. FIG. 3 is a diagram illustrating an example of the road surface profile. In the drawing, the horizontal axis represents the position in the advancing direction of the vehicle 1 along the traveling lane, that is, a distance, and the vertical axis represents an amount (depth or height) of unevenness on the road surface, that is, road surface roughness. In general, as the amount of unevenness on the road surface increases, lateral acceleration of the vehicle 1 increases. Therefore, the road surface property and the lateral acceleration have a predetermined correlation. The road surface profile generation unit 32 calculates the amount of unevenness on the road surface corresponding to the vehicle position on the road from the lateral acceleration by use of such a predetermined correlation, and generates a road surface profile in the advancing direction of the vehicle 1 as illustrated in FIG. 3.

When different vehicles 1 travel in the same lane, the road surface profiles that have been detected by the lateral acceleration sensors of the respective vehicles 1 may be different from each other, because the positions of tires on the road surface are different from each other. In this case, for example, the road surface profile generation unit 32 averages the road surface profiles that have been detected by the lateral acceleration sensors of the respective vehicles 1, and generates a representative road surface profile of each road surface.

The road surface profile generation unit 32 is also capable of generating the road surface profile from data that have been acquired by causing a dedicated vehicle for measuring the road surface property to travel. For example, by causing a dedicated vehicle equipped with a laser profiler to travel and acquiring measurement data at that time together with position data of the dedicated vehicle, it is also possible to generate a road surface profile without use of the lateral acceleration sensor.

The memory unit 33 stores the predetermined correlation between the road surface properties and lateral acceleration used when the road surface profile is generated by the road surface profile generation unit 32, and stores road map information. Road map information includes road location information, road shape (curvature or the like) information, road grade information, position information on intersections and branch points, number of lanes, lane widths, and position information for each lane. The position information for each lane includes information on the center position of the lane and the boundaries of the lane position. In addition, the road map information includes information on the road surface profile (FIG. 3) at each location on the road generated by the road surface profile generation unit 32.

The road surface profile information among the road map information pieces stored in the memory unit 33 is updated each time a road surface profile is generated by the road surface profile generation unit 32. The other road map information are updated at predetermined cycles or at arbitrary times. In the present embodiment, when estimating a traveling lane of the vehicle 1, it is assumed that the road surface profile (reference road surface profile) at the travel position of the vehicle 1 has already stored in the memory unit 33.

FIG. 4 is a block diagram illustrating a functional configuration of a lane estimation apparatus 101 according to the present embodiment. The lane estimation apparatus 101 is included in the in-vehicle device 100 in FIG. 2. As illustrated in FIG. 4, the lane estimation apparatus 101 includes the positioning sensor 10, the communication unit 11, a sensor group 13, a switch group 14, and a controller 20. The positioning sensor 10, the communication unit 11, the sensor group 13, and the switch group 14 are each communicatively connected to the controller 20.

The sensor group 13 is a generic term for a plurality of sensors that detect the driving state of the vehicle 1. The sensor group 13 includes a lateral acceleration sensor 131 that detects the acceleration of the vehicle 1 in the left-right direction. The switch group 14 is a generic term for a plurality of switches that detect the driving state of the vehicle 1. The switch group 14 includes a turn signal switch that detects an operation of a direction indicator by a driver. The direction indicator is a device for indicating the direction to the periphery at the time of the right-left turn or course change of the vehicle 1, and is configured by a turn signal lever or the like.

The controller 20 is an electronic control unit including a computer with a processing unit such as a CPU, a memory unit such as a ROM and a RAM, and other peripheral circuits. The processing unit of the controller 20 has, as its functional configuration, an information acquisition unit 21 and a traveling lane identification unit 25. The information acquisition unit 21 has a position information acquisition unit 211, a precision information acquisition unit 212, a driving information acquisition unit 213, and a road map information acquisition unit 214. Similar to the memory unit 33 of the server device 3, the memory unit of the controller 20 stores predetermined correlations between road surface properties and lateral acceleration used when road surface profiles are generated, and threshold values for making various determinations.

The position information acquisition unit 211 acquires the current position information of the vehicle 1 detected by the positioning sensor 10. The precision information acquisition unit 212 acquires precision information when the position is measured by the positioning sensor 10. The precision of the positioning is influenced by the arrangement of the positioning satellites 2 in the sky, and can be represented mainly by a DOP (Dilution of Precision). That is, as the dilution of precision increases, the precision of positioning decreases. The information on the dilution of precision can be acquired by the positioning sensor 10, for example. The precision information acquisition unit 212 acquires precision information (information on the dilution of precision) via the positioning sensor 10.

The driving information acquisition unit 213 acquires driving information of the vehicle 1 including various detection values detected by the sensor group 13 and the switch group 14. The road map information acquisition unit 214 acquires road map information from the server device 3 via the communication unit 11. More specifically, the road map information acquisition unit 214 acquires the road map information including lane information of the road at the current position of the vehicle 1 detected by the positioning sensor 10 and information of the road surface profile of each lane.

The traveling lane identification unit 25 identifies the traveling lane on which the vehicle 1 travels, based on the current position information of the vehicle 1 acquired by the position information acquisition unit 211, the precision information of the positioning by the positioning sensor 10 acquired by the precision information acquisition unit 212, the driving information of the vehicle 1 acquired by the driving information acquisition unit 213, and the road map information of the road on which the vehicle 1 is traveling acquired by the road map information acquisition unit 214.

Specifically, first, it is determined whether the precision of positioning is equal to or larger than a predetermined value, in other words, whether the DOP is equal to or smaller than a predetermined value al. This is a determination of whether it is possible to precisely identify the lane with use of the position information of the vehicle detected by the positioning sensor 10 in a case where there are a plurality of lanes on the road on which the vehicle 1 is traveling, that is, whether the precision of positioning is maintained enough to be capable of precisely identifying the lane. In order to satisfy such a requirement, the predetermined value al is set beforehand. In a case where it is determined that the DOP is equal to or smaller than the predetermined value al, the traveling lane identification unit 25 identifies the traveling lane of the vehicle 1, based on the position information detected by the positioning sensor 10 and the lane position included in the road map information.

On the other hand, in a case where it is determined that the precision of positioning is smaller than the predetermined value, that is, the DOP is larger than the predetermined value al, the traveling lane is identified, based on a detection value of the lateral acceleration sensor 131 and information of the road surface profile included in the road map information. That is, in this case, since it is difficult to precisely identify the traveling lane with use of the detection value of the positioning sensor 10, the traveling lane identified in a case where the DOP is equal to or smaller than the predetermined value α1 is set as a reference lane, and the current traveling lane is identified by determining whether a lane change from the reference lane has been made with use of the detection value of the lateral acceleration sensor 131.

Specifically, the amount of unevenness on the road surface is calculated from the lateral acceleration that has been detected by the lateral acceleration sensor 131, with use of the correlation between the road surface property that has been stored beforehand and the lateral acceleration. It is to be noted that when the lateral acceleration is generated in the vehicle 1 while the vehicle 1 is traveling and making a turn or the like, such an amount is corrected, and the amount of unevenness on the road surface is calculated from a detection value of the lateral acceleration sensor 131. Then, a road surface profile representing a change in the amount of unevenness on the road surface along the advancing direction of the vehicle 1, that is, an actually measured road surface profile that is an actually measured value of the road surface profile is compared with a road surface profile for every lane included in the road map information, that is, a reference road surface profile, and whether the lane change from the reference lane has been made is determined. For example, in a case where a coincidence degree representing a similarity between the actually measured road surface profile and the reference road surface profile changes from a state of being equal to or larger than a predetermined value to a state of being smaller than the predetermined value, it is determined that the lane change from the reference lane to an adjacent lane has been made, and the current traveling lane is identified accordingly. It is to be noted that it is possible to calculate the coincidence degree by use of a correlation coefficient or the like. The coincidence degree may be referred to as similarity degree.

When determining that the lane change has been made, the traveling lane identification unit 25 may compare the reference road surface profile with the actually measured road surface profile of each lane, and may identify the traveling lane in accordance with the coincidence degree. For example, a lane having the largest coincidence degree may be identified as the current traveling lane.

In a case where it is determined that the DOP is smaller than the predetermined value α1, the traveling lane identification unit 25 further determines whether a lane change from the reference lane has been made, based on a signal from the turn signal switch 141. That is to say, the direction indicator is normally operated at the time of a lane change, and thus the lane change to the left or right of the vehicle 1 is determined based on the signal from the turn signal switch 141. For example, while the vehicle 1 is traveling in the center (a second lane) of three lanes on each side (a first lane, the second lane, and a third lane), even when it is determined whether a lane change has been made by comparing the actually measured road surface profile with the reference road surface profile, it may be impossible to immediately determine to which one of the left and right lanes (the first lane or the third lane) the vehicle 1 has changed the lanes.

In this regard, the turn signal switch 141 detects the operation on the direction indicator in changing the lane of the vehicle 1 to the right lane and the left lane by use of, for example, different switches. Accordingly, not only whether the vehicle has made the lane change but also to which one of the left and right lanes the vehicle 1 has made the lane change can be determined easily, based on the signal from the turn signal switch 141.

When the vehicle 1 changes lanes, the coincidence degree between the actually measured road surface profile and the reference road surface profile is not smaller than a predetermined value, in some cases. Even in such cases, by using the signal from the turn signal switch 141, whether the lane change has been made can be determined satisfactorily. It is to be noted that in consideration that the direction indicator is not always operated at the time of a lane change or there is a possibility that the direction indicator is mistakenly operated, it is preferable that the signal from the turn signal switch 141 be used supplementally in the determination of the lane change.

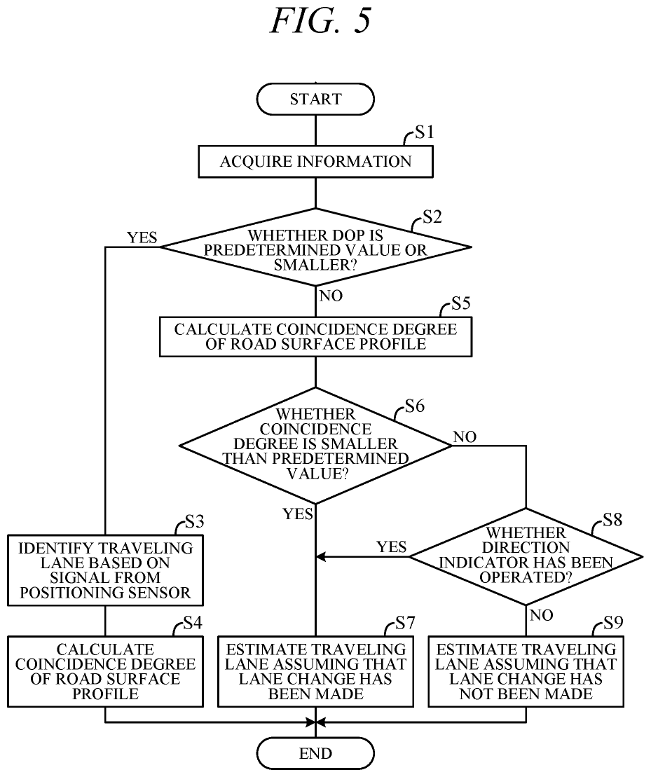

FIG. 5 is a flowchart illustrating an example of processing performed by the controller 20 (CPU) in accordance with a predetermined program. The processing illustrated in the flowchart is performed while the vehicle is traveling, and is repeated at a predetermined cycle. First, in step S1, current position information of the vehicle 1 detected by the positioning sensor 10, precision information in positioning acquired by the positioning sensor 10, driving information of the vehicle 1 by use of signals from the sensor group 13 and the switch group 14, and road map information of a road on which the vehicle 1 travels acquired via the communication unit 11, are acquired.

Next, in step S2, whether the DOP included in the precision information in positioning is equal to or smaller than the predetermined value al. In a case where a positive determination is made in step S2, the processing proceeds to step S3, and a traveling lane on the road map is estimated, based on the current position of the vehicle 1 detected by the positioning sensor 10 and road map data. The estimated traveling lane is stored as a reference lane in the memory unit of the controller 20.

Next, in step S4, the actually measured road surface profile is acquired, based on the detection value of the lateral acceleration sensor 131, the coincidence degree between the actually measured road surface profile and the reference road surface profile (the coincidence degree of the road surface profile) is calculated, and the coincidence degree is stored as a reference value in the memory unit. That is to say, since the coincidence degree between the road surface profiles differ depending on the road surface state, the reference value is not uniformly set regardless of the traveling position, but the reference value is calculated in accordance with the traveling position.

The reference value is updated as needed as the vehicle travels, and the latest reference value is stored in the memory unit.

In a case where a negative determination is made in step S2, the processing proceeds to step S5, and the coincidence degree between the road surface profiles is calculated similarly to step S4. That is to say, the coincidence degree between the actually measured road surface profile and the reference road surface profile is calculated. Next, in step S6, it is determined whether the coincidence degree between the road surface profiles calculated in step S5 is smaller than a predetermined value. The predetermined value in this case is set, based on the reference value stored in step S4. For example, the reference value is set to the predetermined value, or a value acquired by multiplying the reference value by a predetermined coefficient is set to the predetermined value. Accordingly, the predetermined value is set in accordance with the traveling position of the vehicle 1, and thus a satisfactory determination for the lane change is enabled in consideration of the road surface state. It is to be noted that the reference value corresponds to the coincidence degree (similarity degree) serving as a reference for determining the lane change, and the reference value is referred to as a reference similarity degree, in some cases. The predetermined value may be set without considering the reference value.

In a case where a positive determination is made in step S6, the processing proceeds to step S7, and the current traveling lane of the vehicle 1 is estimated assuming that the lane change has been made. For example, as illustrated in FIG. 1, in a case where the traveling lane includes a first lane R1 and a second lane R2 and the vehicle 1 is traveling in the first lane R1 as the reference lane, when the vehicle 1 enters the area AR, it is determined that the DOP is smaller than the predetermined value al. In this situation, in a case where it is determined that the coincidence degree between the road surface profiles is smaller than the predetermined value, the traveling lane is estimated as the second lane R2 assuming that the lane change has been made. The coincidence degree between the actually measured road surface profile measured after it is determined that the lane change has been made and the reference road surface profile of the second lane R2 may be calculated, and whether the lane is the second lane R2 may be determined, based on the coincidence degree. The traveling lane may be estimated accordingly.

In a case where a negative determination is made in step S6, the processing proceeds to step S8, and whether the direction indicator has been operated is determined, based on the signal from the turn signal switch 141. In a case where a positive determination is made in step S8, the processing proceeds to step S7, and the traveling lane is estimated assuming that the lane change has been made. Accordingly, when a lane change is made, in a case where the coincidence degree between the road surface profiles is equal to or larger than the predetermined value, such a lane change can be determined satisfactorily, and the traveling lane can be estimated precisely. In a case where a negative determination is made in step S8, the processing proceeds to step S9, and the traveling lane is estimated assuming that the lane change has not been made.

The operation of the lane estimation apparatus 101 according to the present embodiment is summarized as follows. As illustrated in FIG. 1, in a section Sec1 before reaching the area AR, the traveling lane of the vehicle 1 is identified, based on the position of the vehicle 1 detected by the positioning sensor 10 (step S3). Then, when the vehicle 1 enters the area AR, it is determined whether the vehicle 1 changes lanes from the reference lane, based on the signal from the lateral acceleration sensor 131 assuming that the traveling lane (first lane R1) in the section Sec1 immediately before entering the area AR is set as the reference lane (step S6).

In this situation, in a case where it is determined that the lane change is made, the traveling lane is estimated to be the second lane R2 (step S7). Whether the lane change is made is also determined by a signal from the turn signal switch 141 (step S8). When the vehicle 1 leaves the area AR and starts traveling in a section Sec2, the traveling lane of the vehicle 1 is identified again, based on the position of the vehicle 1 detected by the positioning sensor 10 (step S3).

According to the present embodiment, the following operations and effects are achievable.

(1) A lane estimation apparatus 101 includes: a position information acquisition unit 211 configured to acquire position information of a current position of a vehicle 1 acquired by a positioning sensor 10, the positioning sensor 10 measuring a position of the vehicle 1 by receiving a signal transmitted from a positioning satellite 2; a precision information acquisition unit 212 configured to acquire precision information of positioning by the positioning sensor 10; a driving information acquisition unit 213 configured to acquire driving information of the vehicle 1, the driving information including information of a sensor value of a lateral acceleration sensor 131, the sensor value varying in accordance with a road surface profile of a road surface on which the vehicle 1 is traveling; a road map information acquisition unit 214 configured to acquire road map information including lane information of a road and information of a road surface profile; and a traveling lane identification unit 25 configured to identify a traveling lane in which the vehicle 1 is traveling, based on the position information acquired by the position information acquisition unit 211, the precision information acquired by the precision information acquisition unit 212, the driving information acquired by the driving information acquisition unit 213, and the road map information acquired by the road map information acquisition unit 214 (FIG. 4). The traveling lane identification unit 25 determines whether the precision of positioning is equal to or larger than a predetermined value, based on the precision information acquired by the precision information acquisition unit 212, that is, whether the DOP is equal to or smaller than a predetermined value α1, and in a case where it is determined that the precision of positioning is equal to or larger than the predetermined value, the traveling lane identification unit 25 also identifies the traveling lane, based on the position information acquired by the position information acquisition unit 211 and the road map information acquired by the road map information acquisition unit 214. Then, in a case where it is determined that the precision of positioning is smaller than the predetermined value, that is, the DOP is larger than the predetermined value α1, the traveling lane identification unit 25 determines whether the lane change has been made from the traveling lane identified in the case where it has been determined that the precision of positioning is equal to or larger than the predetermined value, based on the driving information acquired by the driving information acquisition unit 213 and the information of the road surface profile included in the road map information acquired by the road map information acquisition unit 214, and identifies a traveling lane in accordance with a determination result (FIG. 5).

As described above, in the present embodiment, the traveling lane is estimated, based on mainly the signal from the positioning satellite 2. Thus, an error is smaller than that in the case of estimating the traveling lane based on the road surface profile, and the traveling lane can be estimated precisely. When the positioning precision decreases, it is determined whether the lane change has been made from the reference lane before the positioning precision decreases, based on the road surface profile. In other words, the information of the road surface profile is used only for determining the lane change, and the traveling lane is estimated by use of a detection value of the positioning sensor 10 having a small error, as main information. Accordingly, in which one of the plurality of lanes the vehicle 1 is traveling can be estimated satisfactorily. That is, not only in the area AR (FIG. 1) where high-rise buildings are built closely together, but also in various places where the precision of positioning by the positioning sensor 10 decreases, such as in a tunnel, the traveling lane can be precisely estimated by compensating insufficient precision.

(2) The driving information acquired by the driving information acquisition unit 213 further includes operation information of a direction indicator, that is, a signal from a turn signal switch 141 (FIG. 4). After it is determined that the precision of positioning is equal to or larger than the predetermined value (the DOP is equal to or smaller than the predetermined value α1), based on the precision information acquired by the precision information acquisition unit 212, in a case where it is determined that the precision of positioning is smaller than the predetermined value, the traveling lane identification unit 25 identifies the traveling lane, based on the signal from the turn signal switch 141 (FIG. 5). As described above, by using of the operation information of the direction indicator operated at the time of the lane change, the traveling lane can be estimated more precisely.

(3) The precision information acquired by the precision information acquisition unit 212 is information of dilution of precision DOP. As described above, by using the dilution of precision widely known as objective information as the precision information, the lane estimation apparatus 101 with high precision can be easily and inexpensively configured, and the lane estimation apparatus 101 is easily widespread.

(4) The lane estimation apparatus 101 in the present embodiment can also be used as a lane estimation method. A lane estimation method for causing a computer (controller 20) to execute: a step (step S1) of acquiring position information of a current position of a vehicle 1, the position information acquired by a positioning sensor 10 for measuring a position of the vehicle 1 by receiving a signal transmitted from a positioning satellite 2, precision information of positioning by the positioning sensor 10, driving information of the vehicle 1, the driving information including information of a sensor value of a lateral acceleration sensor 131, the sensor value varying in accordance with a road surface profile of a road surface on which the vehicle 1 is traveling, and road map information including lane information of a road and information of a road surface profile; and a step (step S4, step S7, and step S9) of identifying a traveling lane on which the vehicle 1 is traveling, based on the acquired position information, the acquired precision information, the acquired driving information, and the acquired road map information (FIG. 5). Then, the step of identifying the traveling lane includes: determining whether the precision of positioning is equal to or larger than a predetermined value, based on the acquired precision information (whether the DOP is equal to or smaller than a predetermined value +1); in a case where it is determined that the precision of positioning is equal to or larger than the predetermined value, identifying the traveling lane, based on the acquired position information and the acquired road map information (step S4); and then in a case where it is determined that the precision of positioning is smaller than the predetermined value, determining whether the lane change has been made from the traveling lane identified in the case where it has been determined that the precision of positioning is equal to or larger than the predetermined value, based on the acquired driving information and the information of the road surface profile included in the acquired road map information; and identifying the traveling lane in accordance with a determination result (step S7). Accordingly, the lane on which the vehicle 1 is traveling can be estimated precisely.

In the above embodiment, the vehicle position is measured by the positioning sensor 10 by receiving the signal transmitted from the positioning satellite, but the vehicle position may be measured based on the method by the satellite positioning and the method by the inertial navigation. In the above embodiment, the precision information acquisition unit 212 acquires the information of DOP as the precision information by the positioning sensor 10, but a precision information acquisition unit may acquire precision information of the other positioning. When the vehicle position is determined based on the satellite positioning method and the inertial navigation method, the precision information may be acquired by comparing position data obtained by the satellite positioning with position data obtained by the inertial navigation.

In the above embodiment, the driving information acquisition unit 213 acquires driving information of the vehicle 1 including information on the detection values (sensor values) of the lateral acceleration sensor 131, but it may also acquire driving information including information on the detection values of other detectors that vary according to the road surface profile. For example, the driving information acquisition unit may acquire driving information including information on detection values of sensors that detect a roll angle and roll rate, and information on detection values of sensors that detect vibration of the vehicle in the up-down direction. In the above embodiment, the presence or absence of lane change is determined based on the operation information of the direction indicator, but this may be determined based on signals from other sensors or switches. For example, the presence or absence of lane change may be determined using a signal from a sensor that detects a steering angle as driving information.

In the above embodiment, based on the driving information (information on lateral acceleration) acquired by the driving information acquisition unit 213 and the road surface profile information (information on the reference road surface profile) included in the road map information acquired by the road map information acquisition unit 214, the presence or absence of a lane change from the traveling lane identified when it is determined that the precision of positioning is equal to or more than a predetermined value is determined, and the traveling lane is identified according to the determination result. That is, the traveling lane is identified based on the similarity degree (a first similarity degree) between the actually measured road surface profile acquired by the driving information and the reference road surface profile corresponding to the actually measured road surface profile. In addition, the traveling lane may be identified on the basis of a similarity degree (second similarity degree) between the previously stored positional information for each lane, for example, the positional information for each lane on a predetermined road of two lanes on one side, and the position information obtained by the positioning sensor when the vehicle travels on the road. The previously stored position information for each lane is position information obtained by the positioning sensor 10 when the vehicle travels in the lane in advance, and this information is included in the road map information acquired by the road map information acquisition unit 214.

In this case, for example, a region (a first region) in which the traveling lane is determined to be the first lane and a region (a second region) in which the traveling lane is determined to be the second lane may be set in advance in a map of the first lane with the first similarity degree being the horizontal axis and the second similarity degree being the vertical axis, and the traveling lane may be determined using the map. For example, in the second region where the first similarity degree is the first predetermined value or smaller and the second similarity degree is the second predetermined value or smaller, it may be determined that the traveling lane is the second lane, and in the first region where the first similarity degree is larger than the first predetermined value and the second similarity degree is larger than the second predetermined value, it may be determined that the traveling lane is the first lane. In a region where the first similarity degree is larger than the first predetermined value and the second similarity degree is smaller than the second predetermined value (for example, a region in which the second similarity degree is near 0), and in a region where the second similarity degree is larger than the second predetermined value and the first similarity degree is smaller than the first predetermined value (for example, a region in which the first similarity degree is near 0), the traveling lane may not be determined.

In the above embodiment, the lane estimation apparatus 101 is mounted in the vehicle 1, but part or all of the functions of the lane estimation apparatus 101 may be provided in the server device 3. Although in the above embodiment, the lane estimation apparatus 101 is applied to the manual driving vehicle, the lane estimation apparatus 101 of the present invention can be applied to a self-driving vehicle.

The above explanation is an explanation as an example and the present invention is not limited to the aforesaid embodiment or modifications unless sacrificing the characteristics of the invention. The aforesaid embodiment can be combined as desired with one or more of the aforesaid modifications. The modifications can also be combined with one another.

### REFERENCE SIGNS LIST

1 vehicle, 2 positioning satellite, 10 positioning sensor, 11 communication unit, 20 controller, 21 information acquisition unit, 25 traveling lane identification unit, 101 lane estimation apparatus, 131 lateral acceleration sensor, 141 turn signal switch, 211 position information acquisition unit, 212 precision information acquisition unit, 213 driving information acquisition unit, 214 road map information acquisition unit

1-7. (canceled)

8. A lane estimation apparatus, comprising:
an electronic control unit having a microprocessor and a memory connected to the microprocessor, wherein
the microprocessor is configured to perform:
acquiring position information acquired by a positioning sensor, the positioning sensor measuring a position of a vehicle by receiving a signal transmitted from a positioning satellite;
acquiring precision information of positioning by the positioning sensor;
acquiring driving information of the vehicle, the driving information including information on a detection value detected by a detector, the detection value varying in accordance with a road surface profile of a road surface on which the vehicle travels;
acquiring road map information including information on a road lane and information on the road surface profile; and
identifying a traveling lane in which the vehicle travels, based on the position information, the precision information, the driving information, and the road map information, wherein
the microprocessor is configured to perform
the identifying including
determining whether a precision of positioning is equal to or larger than a predetermined value based on the precision information,
identifying the traveling lane based on the position information and the road map information when it is determined that the precision of positioning is equal to or larger than the predetermined value,
determining whether a lane change has been made from the traveling lane identified when it has been determined that the precision of positioning is equal to or larger than the predetermined value, based on the driving information and the information on the road surface profile included in the road map information, when it is determined that the precision of positioning is smaller than the predetermined value since it is determined that the precision of positioning has been equal to or larger than the predetermined value, and
identifying the traveling lane in accordance with a determination result of the lane change.

9. The lane estimation apparatus according to claim 8, wherein
the driving information further includes operation information of a direction indicator, and
the microprocessor is configured to perform
the identifying including identifying the traveling lane based on the operation information of the direction indicator when it is determined that the precision of positioning is smaller than the predetermined value since it is determined that the precision of positioning has been equal to or larger than the predetermined value based on the precision information.

10. The lane estimation apparatus according to claim 8, wherein
the precision information is information on a dilution of precision.

11. The lane estimation apparatus according to claim 8, wherein
the road surface profile included in the road map information is a reference road surface profile, and
the microprocessor is configured to perform
the identifying including
calculating an actually-measured road surface profile defined as an actually measured value of the road surface profile of the road surface on which the vehicle travels, based on the driving information, when it is determined that the precision of positioning is smaller than the predetermined value since it is determined that the precision of positioning has been equal to or larger than the predetermined value based on the precision information,
calculating a similarity degree between the reference road surface profile and the actually-measured road surface profile, and
determining that the lane change has been made when the similarity degree changes from a state of being equal to or larger than a predetermined degree to another state of being smaller than the predetermined degree.

12. The lane estimation apparatus according to claim 11, wherein
the similarity degree is a first similarity degree, and
the microprocessor is configured to perform
the identifying further including calculating a second similarity degree defined as a similarity degree between the position information and position information included in the road map information, and identifying the traveling lane based on the first similarity degree and the second similarity degree.

13. The lane estimation apparatus according to claim 11, wherein
the microprocessor is configured to perform
the identifying including calculating a reference similarity degree defined as a similarity degree between the reference road surface profile and the actually-measured road surface profile when it is determined that the precision of positioning is equal to or larger than the predetermined value based on the precision information, and
the predetermined degree is set based on the reference similarity degree.

14. The lane estimation apparatus according to claim 8, further comprising
an acceleration sensor that detects an acceleration of the vehicle in a left-right direction, wherein
the acceleration sensor is included in the detector.

15. The lane estimation apparatus according to claim 8, further comprising
the positioning sensor;
the detector; and
a communication unit, wherein
the microprocessor is configured to perform
the acquiring the road map information including acquiring the road map information from a server device via the communication unit.

16. A lane estimation method, comprising
acquiring position information acquired by a positioning sensor, the positioning sensor measuring a position of a vehicle by receiving a signal transmitted from a positioning satellite;
acquiring precision information of positioning by the positioning sensor;
acquiring driving information of the vehicle, the driving information including information on a detection value detected by a detector, the detection value varying in accordance with a road surface profile of a road surface on which the vehicle travels;
acquiring road map information including information on a road lane and information on the road surface profile; and
identifying a traveling lane in which the vehicle travels, based on the position information, the precision information, the driving information, and the road map information, wherein
the identifying includes
determining whether a precision of positioning is equal to or larger than a predetermined value based on the precision information,
identifying the traveling lane based on the position information and the road map information when it is determined that the precision of positioning is equal to or larger than the predetermined value,
determining whether a lane change has been made from the traveling lane identified when it has been determined that the precision of positioning is equal to or larger than the predetermined value based on the driving information and the information on the road surface profile included in the road map information, when it is determined that the precision of positioning is smaller than the predetermined value since it is determined that the precision of positioning has been equal to or larger than the predetermined value, and
identifying the traveling lane in accordance with a determination result of the lane change.
